(19) United States
(12) Patent Application Publication
(10) Pub. No.: US 2006/0020928 A1
(43) Pub. Date: Jan. 26, 2006

(54) Translation of comments in code

(75) Inventors: Lane Thomas Holloway, Pflugerville, TX (US); Marques Benjamin Quiller, Pflugerville, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/897,330

(22) Filed: Jul. 22, 2004

(51) Int. Cl. G06F 9/45

(52) U.S. Cl. 717/136

(57) ABSTRACT

Methods, systems, and media are disclosed for translating comments in code. One embodiment includes checking out, from a code repository, code having the comments, which are in a foreign language. Further, the embodiment includes selecting a desired language for translation of the comments, and then identifying the comments in the code to be translated, which are referred to as “identified comments.” The embodiment also includes translating the identified comments from the foreign language into the language selected for translation, which then results in producing translated comments. Finally, the embodiment includes publishing the translated comments, wherein the publishing may be audio, visual or both.

### FIELD OF INVENTION

The invention generally relates to translating comments in code. More particularly, the invention relates to methods, systems, and media for translating comments in code that resides in a code repository, wherein the translating may occur upon checking-in the code, checking-out the code, or both.

### BACKGROUND

Often two or even a team of computer programmers write a computer program's code (“code”). The code, itself, is a set of instructions, written in one or more computer languages, such as xml, C++, and J++, for a computer system to interpret and execute in order to produce the particular program's underlying functionality. The process for writing the code forming the basis of the program is called code development.

Code development is an arduous, complex, and time-consuming task—especially so for code employing novel programming techniques, enabling innumerable functionalities, and requiring thousands or millions of lines of code. In order to meet these daunting challenges, code development may also require detailed design, planning, and architecture even prior to actually writing any lines of code so as to ensure customer requirements are met and to prevent unnecessary duplication of programmers' efforts to forestall waste, i.e., needless expense. After performing these normally preliminary requirements, then the lifecycle for writing the code in code development begins.

The lifecycle for code development, for example, may be explained by four phases: development, test, production, and maintenance. During these phases, the code writing undergoes countless modifications in an effort to produce a final and current version of the code. During these phases of code development, in order to efficiently manage, for example, the programmers writing and modifying the code, as well as the administrators performing maintenance on the code, the code is oftentimes located in a code repository located on a local or remote server and accessible, for example, to a programmer's or administrator's client by network communication. The chosen code repository, itself, may be the dominant, open-source Concurrent Versions System (“CVS”) or a similar, commercially available tool, such as Perforce® or Visual SourceSafe®. Regardless of the chosen code repository, the purpose of the code repository is the same. That is, to store the code being developed and to track the countless code modifications made by programmers and administrators checking-out the code from the code repository and then checking-in the likely modified code into the code repository. As is evident, a code repository is an ideal tool for managing the complexities associated with code development, especially for coordinating the individual efforts by a team of code developers.

Despite code repositories assisting in code development, problems remain as now more fully explained. In conjunction with code development, programmers often include comments with their code. Unlike code, comments are not usually written in a program language such as xml. Instead, comments are usually prosaic explanations written in the language of the programmer or administrator, for example, authoring the comments. Typically, for example, comments explain a particular portion of the code's functionality, identify how or why a particular portion of the code satisfies specification requirements, or explain why the coding was coded in a particularly fashion. Many times, however, the comments are unhelpful, which defeats their fundamental purpose because a language barrier. That is, since code -development of code having comments is oftentimes, and increasingly so, a multinational and/or multilingual effort, a programmer's comments written in French, for example, will not assist another code developer checking-out the code from the code repository if the latter code developer does not understand French; perhaps the latter code developer only speaks Afrikaner. As a result, and by example, the comments are useless unless the latter code developer learns French or seeks the assistance of someone who will translate the comments from French into Afrikaner.

A need, therefore, exists, for methods, systems, and media for translating comments in code, and especially so on immediate demand.

### SUMMARY OF THE INVENTION

Embodiments of the invention generally provide methods, systems, and media for translating comments in code, wherein the comments are a part of the code. In one embodiment, the method generally checking out, from a code repository, the code having the comments in a foreign language. Further, the method includes selecting a language in which the comments are to be translated, and identifying the comments for translation, which results in what is termed “identified comments.” Further still, the method includes translating the identified comments from the foreign language into the language, thereby producing translated comments, and publishing the translated comments.

In another embodiment, the invention provides a system for translating comments in code. The system generally includes a code repository, located on a server, having the code with the comments in a foreign language. Further, the system includes a transfer module, located on a client, for transferring the code with the comments. Further still, the system includes a translator module, located on the server, for translating the comments into a language. And, yet further, the system includes a network in communication with the client and the server.

In yet another embodiment, the invention provides a machine-accessible medium containing instructions for translating comments in code, which when executed by a machine, cause the machine to perform operations. The instructions generally include operations for checking out, from a code repository, the code having the comments in a foreign language. The instructions further include operations for selecting a language for the comments, and for identifying the comments to produce identified comments. Further still, the instructions further include translating the identified comments from the foreign language into the language, thereby producing translated comments, and for publishing the translated comments.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an overview for translating comments in code in accordance with the disclosed invention.

FIG. 2 depicts an example embodiment of a system for translating comments in code in accordance with the disclosed invention.

FIG. 3 depicts an example embodiment of a flowchart for translating comments in code in accordance with the disclosed invention.

FIG. 4 depicts an example embodiment of a computer system capable of use for translating comments in code in accordance with the disclosed invention.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for translating comments in computer program code (“code”) are contemplated. Embodiments include a client, such as a computer system, used, for example, by a computer programmer desiring to write code having comments in a foreign language or an administrator performing maintenance on code having comments in a foreign language. By network communication, such as a LAN or WAN, the client communicates with a server having a code repository containing the code having comments in the foreign language and being developed or undergoing maintenance. The code repository, itself, may be the dominant, open-source Concurrent Versions System (“CVS”) or a similar, commercially available tool, such as Perforce® or Visual SourceSafe®. After the client checks-out the code having comments in a foreign language from the code repository on the server, the client selects a desired language for translating the comments in the checked-out code. The translation capabilities are enabled by software and/or hardware located on the same or a different server as the code repository, and via the same or a different network communication with the client. Translation, optionally transparent, of the checked-out code having comments in the foreign language allows the client to view the comments in the selected language on demand rather than, for example, seeking and waiting for someone to translate the comments in the foreign language. With the client now having the translated comments associated with the checked-out code, the programmer, for example, may continue developing the code, for example, which may result in the programmer optionally modifying the comments existing at the time of check-out. Upon the client checking-in the code having optionally modified comments in the programmer's language (i.e., the selected language), further logic enabled by software and/or hardware tracks the changes made to the comments compared to check-out. If no comment changes occurred, then translation back from the selected language to the foreign language is unnecessary for checking-in the code to the code repository. However, if modifications to the original comments occurred, then the tracking logic communicates with the translation logic to translate these modifications to the comments from the selected language into the foreign language upon check-in to the code repository.

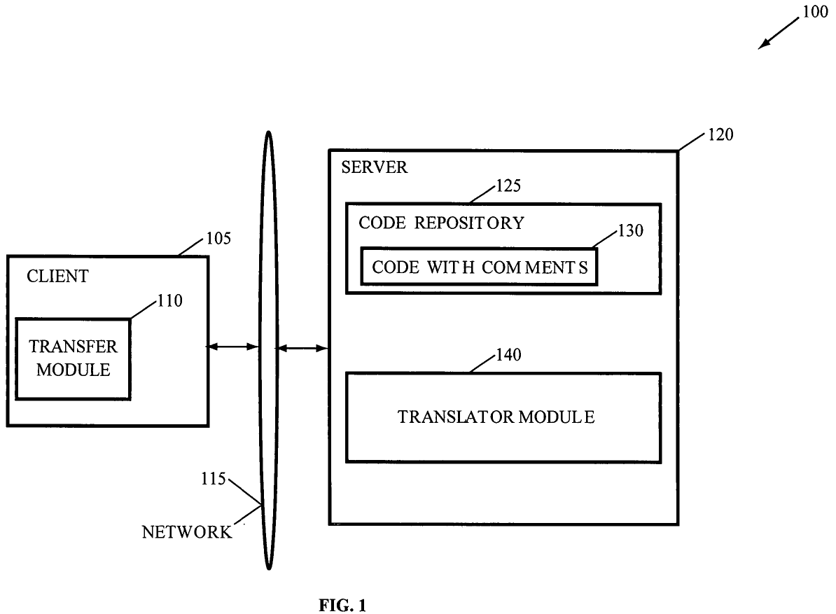

Turning now to FIG. 1, this figure depicts a system 100 further elucidating the general overview of the invention. The system 100 shows a client 105, such as a computer system used by a programmer or administrator, in network communication 115 with a server 120. The client 105, includes a transfer module 110, enabled by logic reduced to hardware and/or in software, that provides enabling capabilities for transferring code having comments 130. The transferring, itself, permits communication over a network 115 for example, with a code repository 125 located on a server 120. That is, the transfer module 110 operates to request and transfer, either checking-in or checking-out, code having comments 130 from the code repository 125. As previously explained, the code repository 125, is a tool, such as CVS, for managing the often extensive coordination efforts required for a team of programmers, administrators, and the like involved with code development.

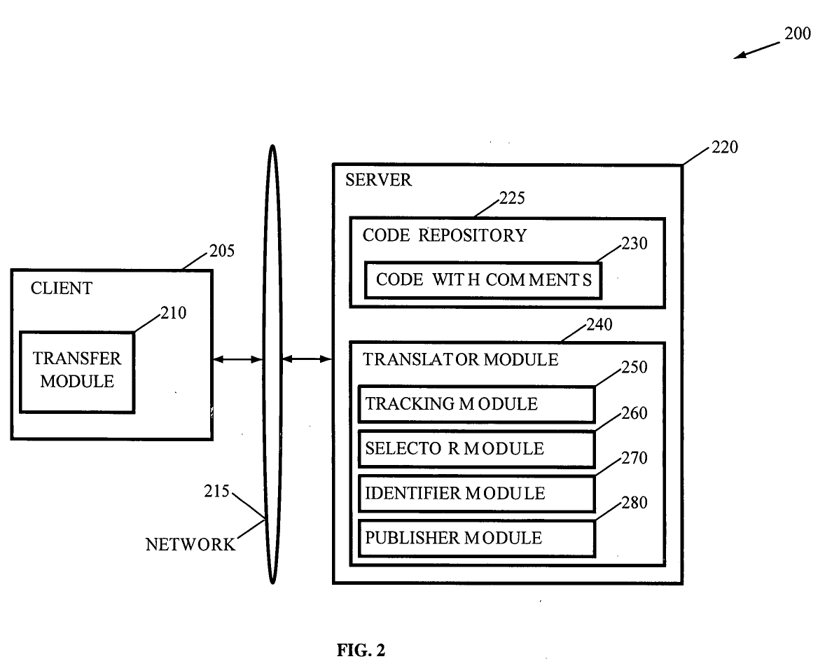

After a first execution of the transfer module 110, the client 105 receives the code with the comments 130, wherein the comments are in a foreign language. By foreign language, this means a language that is not understood by the client and desired to be translated into the client's 105 selected language; or, if understood, then the client, for whatever reason, still desires the comments to be translated to the client's 105 selected language. The client 105 selects the desired language through network communication 115, for example, with the server 120 or another server, although not depicted, having a translator module 140. As more fully explained in FIG. 2, the translator module 140 provides the functionality for translating the code having comments 130 in the foreign language to the language selected by the client 105 after checking-out the code having the comments 130 from the code repository 125 on the server 120 via network communication 115 through the transfer module 110. In addition, further enabling logic associated with the translator module 140 translates any modifications to the comments, which a programmer, for example, makes in the selected language through a non-depicted editor associated with and used by the client 105 in its code development environment. The translation of the modifications to the comments in the selected language occurs by the translator module 140 upon the client's 105 check-in of the code with optional modifications to code repository 125 via the transfer module 110 over network communication 115.

Turning now to FIG. 2, a more detailed, example embodiment of the invention is disclosed. FIG. 2 depicts a system 200 very similar to system 100 in FIG. 1, but with greater elucidation of the translator module 140, 240. Carrying forward rather than repeating the previous discussion of FIG. 1, the discussion of FIG. 2 primarily centers on the previously undiscussed, i.e., the modules 250, 260, 270, and 280 associated with the translator module 240.

After the client 205 checks-out, via the transfer module 210, the code with comments 230 in the foreign language from the code repository 225 on the server 220 in network communication 215 with the client 205, the system 200 begins its translation phase. That is, the client 205, by network communication 215, for example, communicates with the translator module 240 located on the same server 220 as the code repository 225. Optionally, the translator module 240 may be located on a different server than server 220, but, the client 205 must still be in communication somehow, such as network communication 215 with that different server. Optionally, again, rather than the client 205 repeatedly communicating over a network 215 with the translator module 240 on the server 220 to invoke its associated modules' functionalities, which are enabled by software and/or hardware, by, the translator module 240 may also be a downloadable application. Regardless of the client's 205 remote or local (i.e., after download) communication with the translator module 240, further enabling logic in software and/or reduced to hardware permits interfacing of the transfer module 210 to the translator module 240. Thereby, optional and latter check-in to the code repository 225 of the code having the comments 230 with optional comment modifications in the selected, translated language, as more fully explained below, occurs.

Turning now to the specific modules 250, 260, 270, and 280 associated with the translating performed by the translator module 240, it is understood that these specific modules 250, 260, 270, and 280 may be optionally integrated into the translator module 240 or optionally associated with the translator module 240 on the same or a different server as the translator module 240. Solely for clarity of discussion, however, FIG. 2 depicts one example embodiment of the invention, wherein the specific modules 250, 260, 270, and 280 are shown to be integrated into the translator module 240.

The selector module 260, enabled by software and/or hardware logic, permits the client 205 to select a language that the client 205 desires for the translation of the comments in the checked-out code having comments 230 in a foreign language. The selector module's 260 interface for the client 205 to select the desired language may be any interface allowing the client 205 to select a language. For example, the selector module 260 may provide an interface initiated by the client 205 using a selecting device, such as a keyboard key or a mouse. Continuing the example, by right-clicking on the checked-out code, the client 205 initiates communication with the selector module 260 over a network 215, and the selector module 260 produces a pop-up menu, having optional sub-menus to traverse, for the client to select a language from a group of languages provided as choice for translation of the comments. By another example, the selector module 240, in communication with the code repository 225, may automatically query the client 205 for a textual entry of a desired language for translation of the comments after the client 205 checks-out the code having the comments in the foreign language. It is apparent that the specific interface utilized by the selector module 260 for the client 205 to use for selecting a language for translation of the comments from the foreign language is limitless, and the above examples are understood to be non-limiting examples.

The identifier module 270, enabled by software and/or hardware logic, permits the translator module 240 to identify the comments in the code having comments. The logic for identifying the comments in the code is for enabling the translator module 240, through the identifier module 270, to analyze and determine the comments within the code; that is, an identification of what are the comments and not the code. By example, the enabling logic may be a wizard automatically invoked after execution of the selector module 270, wherein the wizard, for example, identifies comments as any line in the code beginning with “/*” and ending in “*/”, and/or having a “c” in the seventh column, and/or beginning with “//.” Again, these examples are understood to be non-limiting examples of the identifier module's 270 enabling logic for identifying the comments of the code.

After execution by the selector module 260 and identifier modules 270, enabling logic associated with the translator module 240, itself, translates the comments from the foreign language into the selected language in a transparent fashion to the end-user, i.e., client 205. The enabling logic for the actual translation is a translator program having capabilities for translating multiple languages—the more the better from a utility perspective. The translator program, itself, may be a commercially available translator program e.g., Babblefish™, or an independently developed translator program. Regardless, the functionality is the same: translation of the identified comments from the foreign language into the selected language. As previously discussed, the translation occurs at the client 205 optionally as a result of downloading the translator module 240 or by repeated network communication 215 with the translator module 240.

After translation of the identified comments into the selected language, the publisher module 280, enabled by logic, publishes the translated comments to the client 205. The publishing is a textual display of the translated comments onto, for example, a video display, such as a monitor associated with the client 205. The publishing of the translated comments may also be audio, such as through speakers associated with the client 205.

The foregoing discussion details an example embodiment for translating checked-out code having comments 230 by the transfer module 210 in network communication 215 with and from a code repository 225 on a server 220. In a further example embodiment, however, the translator module 240 is also enabled, by software and/or hardware logic, for translating added or subtracted comments (collectively, “modifications”) to the code made by a programmer using a code editor, for example, at the time of checking the code back into the code repository 225. The tracking module 250 associated with the translator module 240 tracks the modifications, which are presumably made by the client 205 in the language selected for translating the checked-out code having comments 230 in a foreign language. The logic associated with the tracking module 250 compares, for example, the code having comments 230 in the foreign language to the modifications in the language to determine whether there are any modifications. If there are modifications, then the tracking module 240, working in tandem and in communication with the translator module 240, translates the modifications into the foreign language. In this manner, the code with the comments 230 and any modifications checked into the code repository 225 are in the same “foreign” language, and latter clients accessing the code repository 225 to check-out the code having comments 230, now including the modifications, will check-out the code having comments in the same “foreign” language, whether or not the language is actually foreign to the latter clients.

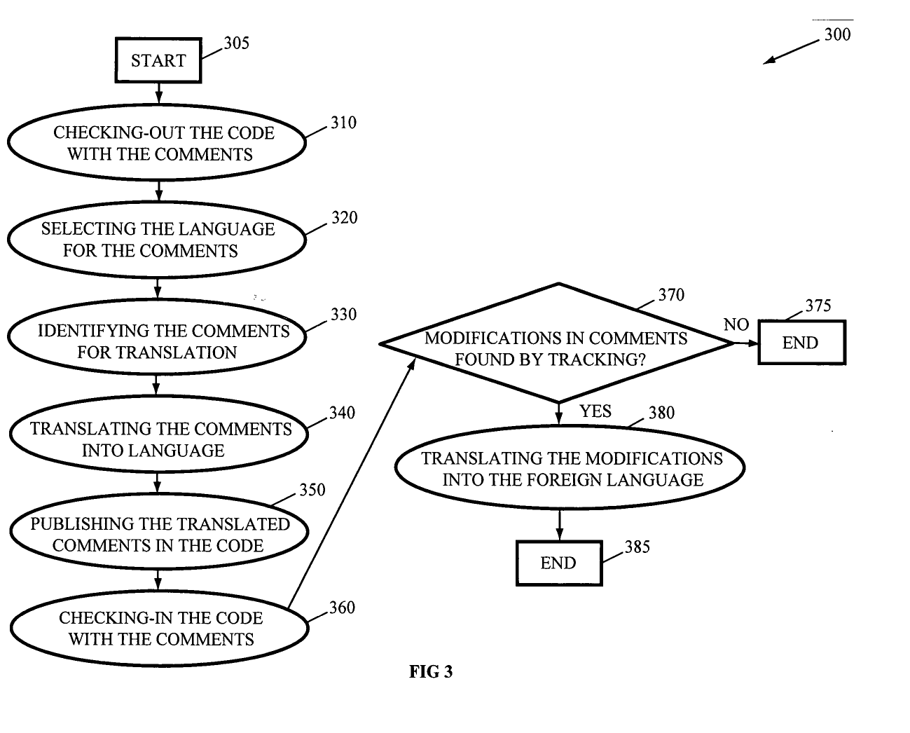

Turning now to FIG. 3, another aspect of the invention is disclosed. In particular, an embodiment of a flowchart 300 for translating comments in code is disclosed. Flowchart 300 is for a system, such as systems 100 and 200, as shown in FIG. 1 and FIG. 2.

Flowchart 300 begins with a start box 305 pointing to checking-out 310 the code having comments in a foreign language, i.e., a language that the client checking-out either does not understood or desires to be different. The checked-out 310 code having comments is located in a code repository, such as Perforce® or Visual SourceSafe®, on a server in network communication, for example, with a client, such as a computer system used by a programmer or administrator. Such users of the client are likely participating in code development, and may be checking-out 310 the code having the comments to view it and/or make changes, for whatever reason, to it. In order to check-out 310 the code having comments, security measures are likely in place and enforced to ensure that only authorized code developers, for example, are enabled to perform check-outs 310.

After check-out 310, the client may select 320 the desired language for the comments associated with the code. Enabling logic associated with selecting 320 the language may, for example, include a prompting interface, either automatically or manually, for the client to select a language desired for viewing the comments associated with the checked-out 310 code. The automatic prompting to the client may occur by the code repository communicating and notifying a selector module, for example, that the client has checked-out the code having comments. Or, the manual prompting by the client may occur by the client requesting and receiving network communication with a selector module, for example, in order to select a language for the comments received after checking out 310 the code with the comments. The selecting 320, for example, of the desired language by the client may be an interface providing a pre-determined list of selectable languages, or may be a pop-up menu, having optional sub-menus to traverse, for the client to ultimately select the desired language for translating the comments received at check-out 310. Other examples for selecting 320 exist, and the above examples are understood to be non-limiting.

The flowchart 300 continues by identifying 330 the comments in the checked-out 310 code. The client, through network communication, for example, communicates with a server for example having enabling logic, such as a wizard, to analyze and find the comment in the checked-out 310 code. In the alternative, the client may have already downloaded such enabling logic to the client from a server. Regardless of the non-limiting example methodologies disclosed for identifying 330 the comments, the identified comments are ready for translation into the selected 320 language.

Translating 340 the identified 330 comments into the selected 320 language occurs through a translation program, such as Babblefish™, with which the client communicates either locally or remotely to produce the translated 340 comments for the client. Afterwards, the translated 340 comments are published 350 via enabling logic with which the client communicates either locally or remotely. For example, the publishing 350 of the translated comments occurs by video display on a screen associated with the client, by speakers associated with the client, or both.

The flowchart 300 culminates with checking-in 360 the code that was optionally modified 370. If the client makes modifications to the comments of the code through an editor, for example, associated with the client's code development environment, then a further aspect of the invention is depicted by decision block 370 that queries whether there are modifications 370 in the comments found by tracking. The tracking, enabled by software and/or hardware logic searches the comments with optional comment modifications, presumably made in the selected language, and compares those modifications to the checked-out 310 comments. If modifications exist, then the translating program, working in tandem with the tracking logic, translates 380 the modifications upon checking-in 360 the code back to the code repository and the flowchart 300 ends 385. If no modifications exist, then no translation is necessary, and the flowchart 300 ends 375.

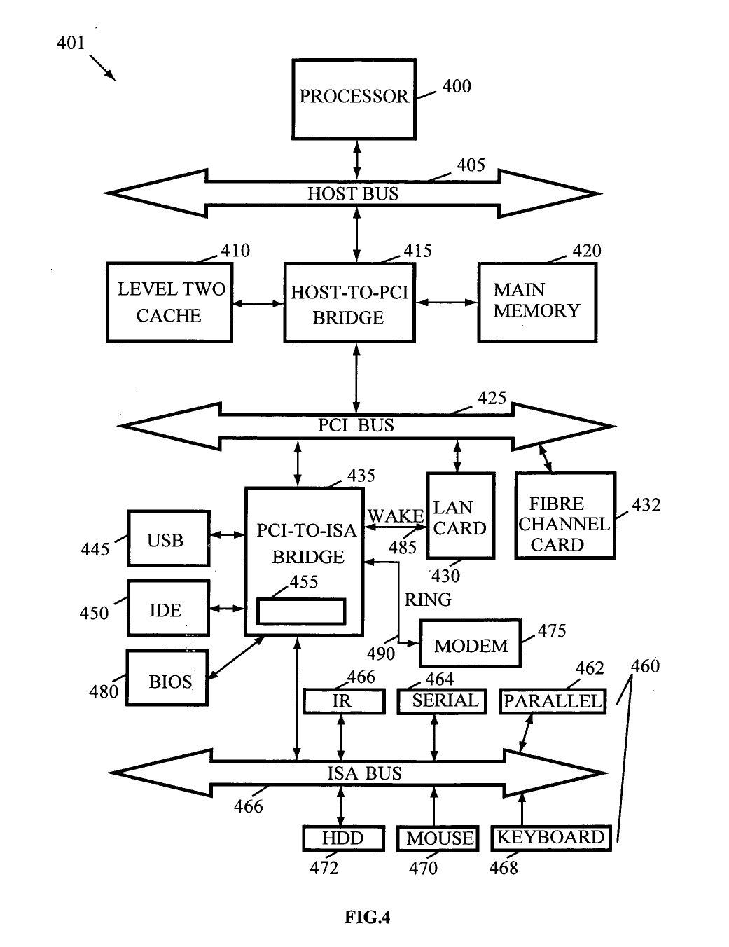

FIG. 4 illustrates information handling system 401 which is a simplified example of a computer system, such as the client 105, 205 and server 120, 220 found in FIGS. 1, 2, capable of performing the operations described herein. Computer system 401 includes processor 400 which is coupled to host bus 405. A level two (L2) cache memory 510 is also coupled to the host bus 405. Host-to-PCI bridge 415 is coupled to main memory 420, includes cache memory and main memory control functions, and provides bus control to handle transfers among PCI bus 425, processor 400, L2 cache 410, main memory 420, and host bus 405. PCI bus 425 provides an interface for a variety of devices including, for example, LAN card 430. PCI-to-ISA bridge 435 provides bus control to handle transfers between PCI bus 425 and ISA bus 440, universal serial bus (USB) functionality 445, IDE device functionality 450, power management functionality 455, and can include other functional elements not shown, such as a real-time clock (RTC), DMA control, interrupt support, and system management bus support. Peripheral devices and input/output (I/O) devices can be attached to various interfaces 460 (e.g., parallel interface 462, serial interface 464, infrared (IR) interface 466, keyboard interface 468, mouse interface 470, fixed disk (HDD) 472, removable storage device 474) coupled to ISA bus 440. Alternatively, many I/O devices can be accommodated by a super I/O controller (not shown) attached to ISA bus 440.

BIOS 480 is coupled to ISA bus 440, and incorporates the necessary processor executable code for a variety of low-level system functions and system boot functions. BIOS 480 can be stored in any computer readable medium, including magnetic storage media, optical storage media, flash memory, random access memory, read only memory, and communications media conveying signals encoding the instructions (e.g., signals from a network). In order to attach computer system 401 to another computer system to copy files over a network, LAN card 430 is coupled to PCI bus 425 and to PCI-to-ISA bridge 435. Similarly, to connect computer system 401 to an ISP to connect to the Internet using a telephone line connection, modem 475 is connected to serial port 464 and PCI-to-ISA Bridge 435.

While the computer system described in FIG. 4 is capable of executing the invention described herein, this computer system is simply one example of a computer system. Those skilled in the art will appreciate that many other computer system designs are capable of performing the invention described herein.

Another embodiment of the invention is implemented as a program product for use with a computer system such as, for example, the systems 100 and 200 shown in FIG. 1 and FIG. 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

What is claimed is:

1. A method for translating comments in code, the method comprising:
checking out, from a code repository, the code having the comments in a foreign language;
selecting a language for the comments;
identifying the comments to produce identified comments;
translating the identified comments from the foreign language into the language, thereby producing translated comments; and
publishing the translated comments.

2. The method of claim 1, further comprising tracking modifications to the comments in the language after the translating.

3. The method of claim 2, further comprising:
checking into the code repository the code with the comments and the modifications in the language; and
translating the modifications and the comments from the language into the foreign language.

4. The method of claim 1, wherein the selecting comprises selecting, via a selecting device, from a group of languages, wherein the group has the language.

5. The method of claim 1, wherein the selecting comprises selecting, via a selecting device, on a portion of the code resulting in popping-up a menu, optionally having one or more sub-menus, for selecting the language.

6. The method of claim 1, wherein the identifying comprises analyzing the code to determine the comments.

7. The method of claim 1, wherein the publishing the translated comments comprises displaying the translated comments on a screen.

8. A system for translating comments in code, the system comprising:
a code repository, located on a server, having the code with the comments in a foreign language;
a transfer module, located on a client, for transferring the code with the comments;
a translator module, located on the server, for translating the comments into a language; and
a network in communication with the client and the server.

9. The system of claim 8, wherein the translator module further comprises a tracking module for tracking modifications to the comments in the language after an execution by the transfer module.

10. The system of claim 9, wherein the translator module further comprises translating the modifications from the language into the foreign language after another execution by the transfer module.

11. The system of claim 8, wherein the translator module comprises a selector module for selecting the language for the comments.

12. The system of claim 8, wherein the translator module further comprises an identifier module for identifying the comments in the code.

13. The system of claim 8, wherein the translator module further comprises a publisher module for publishing the comments after execution by the translator module.

14. The system of claim 8, wherein the translator module comprises a downloadable application.

15. A machine-accessible medium containing instructions, which when executed by a machine, cause the machine to perform operations for translating comments in code, comprising:
checking out, from a code repository, the code having the comments in a foreign language;
selecting a language for the comments;
identifying the comments to produce identified comments;
translating the identified comments from the foreign language into the language, thereby producing translated comments; and
publishing the translated comments.

16. The machine-accessible medium of claim 15, wherein the instructions further comprise operations for tracking modifications to the comments in the language after executing the instructions for the translating.

17. The machine-accessible medium of claim 16, wherein the instructions further comprise operations for checking into the code repository the code with the comments and the modifications in the language, and for translating the modifications and the comments from the language into the foreign language.

18. The machine-accessible medium of claim 15, wherein the instructions for selecting comprise selecting, via a selecting device, from a group of languages, wherein the group has the language.

19. The machine-accessible medium of claim 15, wherein the instructions for selecting comprise selecting, via a selecting device, on a portion of the comments resulting in popping-up a menu, optionally having one or more sub-menus, for selecting the language.

20. The machine-accessible medium of claim 15, wherein the instructions for identifying comprises analyzing the code to determine the comments.
